(19) United States
(12) Patent Application Publication
(10) Pub. No.: US 2024/0201411 A1
(43) Pub. Date: Jun. 20, 2024

(54) CAPACITANCE SENSOR AND CAPACITANCE SENSOR MANUFACTURING METHOD

(71) Applicants: HONDA MOTOR CO., LTD., Tokyo (JP); The University of British Columbia, Vancouver (CA)

(72) Inventors: Ryusuke Ishizaki, Wako-shi (JP); Fumiya Hamatsu, Wako-shi (JP); John D W Madden, Vancouver (CA); Kieran Morton, Surrey (CA); Austin Weir, Burnaby (CA); Mirza Saquib Sarwar, Vancouver (CA)

(21) Appl. No.: 18/539,523

(22) Filed: Dec. 14, 2023

(30) Foreign Application Priority Data
Dec. 16, 2022 (JP) 2022-201140

(51) Int. Cl. G01V 3/08

(52) U.S. Cl. CPC G01V 3/088

(57) ABSTRACT

A capacitance sensor made of a plurality of layers includes: a first layer including a first electrode; and a second layer including a second electrode and arranged to face the first layer, wherein at least one of the first layer and the second layer is an elastomer layer which is a dielectric and is made of an elastically deformable elastomer, and the elastomer layer is bonded by an adhesion layer formed by applying an elastomer in a pre-curing state that is a material identical to the first layer or the second layer and curing the elastomer.

### CROSS-REFERENCE TO RELATED APPLICATION

Priority is claimed on Japanese Patent Application No. 2022-201140, filed on Dec. 16, 2022, the contents of which are incorporated herein by reference.

### BACKGROUND

### Field of the Invention

The present invention relates to a capacitance sensor and a capacitance sensor manufacturing method.

### Background

A flexible capacitance sensor is used as a tactile sensor or the like. In such a capacitance sensor, the position between electrodes spaced from each other and facing each other is changed, and thereby, predetermined sensing is enabled.

The detection characteristic in a sensor is greatly affected by the amount of change in a relative position such as a distance between laminated electrodes. Accordingly, a structure is required which maintains the electrodes in a predetermined relative positional relationship and supports the electrodes to be promptly displaceable in response to a sensing amount. As such a structure for supporting electrodes, for example, a configuration is known in which layers formed of a flexible elastomer or the like are laminated. When manufacturing a sensor having such a structure, laminated flexible layers are bonded to each other.
Patent Document 1 (Japanese Unexamined Patent Application, First Publication No. 2009-154443), Patent Document 2 (Japanese Unexamined Patent Application, First Publication No. H02-233242), Patent Document 3 (Published Japanese Translation No. 2021-508747 of the PCT International Publication), and Patent Document 4 (Japanese Unexamined Patent Application, First Publication No. 2016-026552) disclose techniques relating to bonding in flexible elastic materials such as an elastomer.

### SUMMARY

However, Patent Documents 1 to 4 do not describe preferable techniques used for bonding of flexible layers such as an elastomer in the manufacturing of capacitance sensors.

Specifically, in order to maintain a required sensor characteristic, a deformation characteristic with respect to stress is required to match each other between a flexible layer such as an elastomer and an adhesive bond, but the techniques described in Patent Documents 1 to 4 are insufficient. At the same time, the deformation characteristic with respect to stress is required to be uniform, but the bonding techniques described in Patent Documents 1 to 4 are insufficient.

Further, in the flexible capacitance sensor, deformation is assumed, and it is required that the flexible layer such as an elastomer and the adhesive bond not be peeled. However, in the techniques described in Patent Documents 1 to 4, there is a problem in that stress is easily concentrated, and peeling easily occurs.

An aspect of the present invention aims at providing a capacitance sensor in which flexibility does not differ between sensor portions laminated by way of an adhesive bond, a deformation degree is uniform, the flexibility characteristic of the sensor is constant, and sensitivity is not decreased, and which is capable of preventing stress concentration and peeling from occurring.

A first aspect of the present invention is a capacitance sensor made of a plurality of layers, the capacitance sensor including: a first layer including a first electrode; and a second layer including a second electrode and arranged to face the first layer, wherein at least one of the first layer and the second layer is an elastomer layer which is a dielectric and is made of an elastically deformable elastomer, and the elastomer layer is bonded by an adhesion layer formed by applying an elastomer in a pre-curing state that is a material identical to the first layer or the second layer and curing the elastomer.

A second aspect is the capacitance sensor according to the first aspect described above which may include, between the first layer and the second layer, a plurality of pillars extending in a lamination direction, in which the first layer and the second layer face each other, and arranged to be spaced from each other in a direction intersecting the lamination direction, wherein the pillars may be bonded by the adhesion layer, which is a material made of an elastomer identical to the first layer or the second layer.

A third aspect is the capacitance sensor according to the second aspect described above, wherein the pillar may be integrally formed with at least one of the first layer and the second layer.

A fourth aspect of the present invention is a capacitance sensor manufacturing method of a capacitance sensor made of a plurality of layers and including: a first layer including a first electrode: and a second layer including a second electrode arranged to face the first layer, the capacitance sensor manufacturing method including: a preparation step in which an elastomer layer that is a dielectric and is made of an elastically deformable elastomer is formed as at least one of the first layer and the second layer; and a bonding step in which an elastomer in a pre-curing state that is a material identical to the first layer or the second layer is applied and then cured, and an adhesion layer that bonds the elastomer layer is formed.

A fifth aspect is the capacitance sensor manufacturing method according to the fourth aspect described above, wherein a plurality of pillars that extend in a lamination direction in which the first layer and the second layer face each other, are arranged to be spaced from each other in a direction intersecting the lamination direction, and are a material identical to the first layer or the second layer may be provided between the first layer and the second layer, and in the bonding step, the pillars may be bonded by the adhesion layer.

According to the first aspect described above, by bonding the laminated elastomer layer using the adhesive bond made of the same material, the flexibility at this bonding location is not changed, and uniform flexibility is achieved. That is, at the bonding location using the adhesive bond, the degree of deformation corresponding to stress can be uniform, and it is possible to prevent a non-uniform state with respect to variation in a relative position between the electrodes caused by the bonding. Thereby, the capacitance change due to the relative displacement between the electrodes can be set to a predetermined state, and deterioration of the sensor characteristic can be prevented.

Here, on the bonding surface between the elastomer layer and the adhesive bond that are the same material, it is not necessary for the elastomer layer and the adhesive bond to bond each other at a molecular level, and sufficient bonding and peeling resistance properties can be achieved by a pre-curing adhesive bond entering minute irregularities formed on the bonding surface of the elastomer layer and by the adhesive bond being cured in this state.

According to the second aspect described above, by bonding using the adhesive bond, the pillar formed between the first layer and the second layer each having an electrode, in a pillar in which the position displacement between the electrodes is large even when the same external force is applied, the degree of deformation corresponding to the stress can be the same as the adhesive bond, and it is possible to prevent deterioration of the detection accuracy as a sensor caused by the flexibility of the adhesive bond differing from the flexibility of the pillar. Accordingly, the detection accuracy as a sensor can be improved.

Further, by setting the formation size of the pillar in a direction along the facing surfaces of the electrodes in a predetermined state, when using a configuration in which the direction of the external force detected as the sensor is appropriately set, in a pillar that defines a predetermined sensor characteristic, it is possible to prevent deterioration of the detection accuracy as the sensor characteristic caused by the flexibility of the adhesive bond differing from the flexibility of the pillar. Thereby, it becomes possible to provide a sensor capable of improving the detection accuracy which is a predetermined sensor characteristic.

According to the third aspect described above, by bonding using the adhesive bond, the pillar that defines the relative displacement between the electrodes directly relating to the detection characteristic of the sensor, in a pillar in which the position displacement between the electrodes can be increased even when the same external force is applied, it is possible to prevent deterioration of the detection accuracy as a sensor caused by the flexibility of the adhesive bond differing from the flexibility of the pillar. Accordingly, the detection accuracy as a sensor can be improved.

Further, by setting the formation size of the pillar in a direction along the facing surfaces of the electrodes in a predetermined state, when using a configuration in which the direction of the external force detected as the sensor is appropriately set, in a pillar that defines a predetermined sensor characteristic, it is possible to prevent deterioration of the detection accuracy as the sensor characteristic caused by the flexibility of the adhesive bond differing from the flexibility of the pillar. Thereby, it becomes possible to provide a sensor capable of improving the detection accuracy which is a predetermined sensor characteristic.

According to the fourth aspect described above, by bonding the laminated elastomer layer using the adhesive bond made of the same material, the flexibility at this bonding location is not changed, and uniform flexibility is achieved. That is, at the bonding location using the adhesive bond, the degree of deformation corresponding to stress can be uniform, and it is possible to prevent a non-uniform state with respect to variation in a relative position between the electrodes caused by the bonding. Thereby, the capacitance change due to the relative displacement between the electrodes can be set to a predetermined state, and it is possible to provide a capacitance sensor capable of preventing deterioration of the sensor characteristic.

According to the fifth aspect described above, by bonding using the adhesive bond, the pillar between the first layer and the second layer each having an electrode, in a pillar in which the position displacement between the electrodes can be increased even when the same external force is applied, it is possible to prevent deterioration of the detection accuracy as a sensor caused by the flexibility of the adhesive bond differing from the flexibility of the pillar. Accordingly, the detection accuracy as a sensor can be improved.

Further, by setting the formation size of the pillar in a direction along the facing surfaces of the electrodes in a predetermined state, when using a configuration in which the direction of the external force detected as the sensor is appropriately set, in a pillar that defines a predetermined sensor characteristic, it is possible to prevent deterioration of the detection accuracy as the sensor characteristic caused by the flexibility of the adhesive bond differing from the flexibility of the pillar. Thereby, it becomes possible to provide a sensor capable of improving the detection accuracy which is a predetermined sensor characteristic.

According to an aspect of the present invention, by having a uniform deformation characteristic without changing the same flexibility on the bonding surface, it becomes possible to provide advantages such as preventing the sensor characteristic from becoming non-uniform, preventing peeling from occurring by the bonding location being tightly bonded, realizing multi-function use since additional lamination can be made with the same sensor characteristic, and providing a capacitance sensor capable of realizing a complex pillar structure that achieves high sensitivity and a wide dynamic range.

### BRIEF DESCRIPTION OF THE DRAWINGS

FIG. 1 is a schematic cross-sectional view showing a capacitance sensor and a capacitance sensor manufacturing method according to a first embodiment of the present invention.

FIG. 2 is a flowchart showing a process in the capacitance sensor manufacturing method according to the first embodiment.

FIG. 3 is a cross-sectional view showing the process in the capacitance sensor manufacturing method according to the first embodiment.

FIG. 4 is a cross-sectional view showing the process in the capacitance sensor manufacturing method according to the first embodiment.

FIG. 5 is a cross-sectional view showing an operation of the capacitance sensor manufacturing method according to the first embodiment.

FIG. 6 is a cross-sectional view showing a capacitance sensor and a capacitance sensor manufacturing method according to a second embodiment of the present invention.

FIG. 7 is a perspective view showing a process in the capacitance sensor manufacturing method according to the second embodiment.

FIG. 8 is a perspective view showing a process in the capacitance sensor manufacturing method according to the second embodiment.

FIG. 9 is a cross-sectional view showing an operation of the capacitance sensor according to the second embodiment.

FIG. 10 is a cross-sectional view showing an operation of the capacitance sensor according to the second embodiment.

FIG. 11 is a view showing a relationship between a vertical load and a deformation amount for describing the operation of the capacitance sensor according to the second embodiment.

FIG. 12 is a cross-sectional view showing another example of a pillar in the capacitance sensor and the capacitance sensor manufacturing method according to the second embodiment.

FIG. 13 is a cross-sectional view showing still another example of a pillar in the capacitance sensor and the capacitance sensor manufacturing method according to the second embodiment.

FIG. 14 is a cross-sectional view showing still another example of a pillar in the capacitance sensor and the capacitance sensor manufacturing method according to the second embodiment.

### DESCRIPTION OF EMBODIMENTS

Hereinafter, a capacitance sensor and a capacitance sensor manufacturing method according to a first embodiment of the present invention will be described with reference to the drawings.

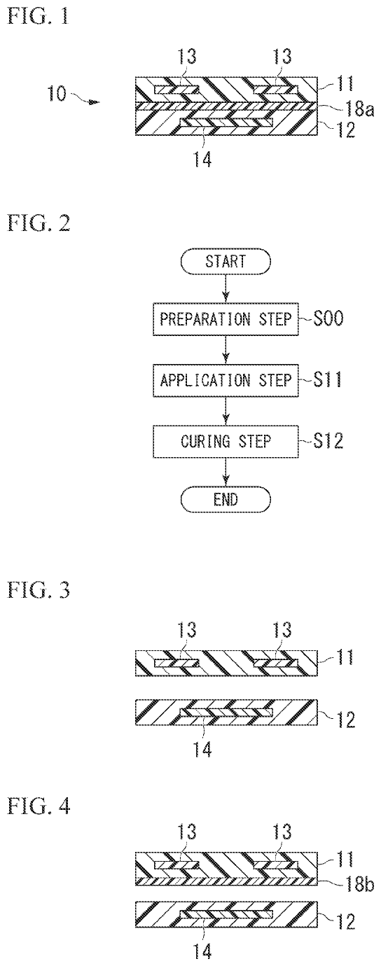

FIG. 1 is a cross-sectional view showing a capacitance sensor in the present embodiment. In FIG. 1, reference numeral 10 represents a capacitance sensor.

The capacitance sensor 10 according to the present embodiment includes: a first electrode support layer (first layer) 11 including a first electrode 13, a second electrode support layer (second layer) 12 including a second electrode 14 and arranged to face the first electrode support layer 11: and an adhesion layer 18a made of an adhesive bond, as shown in FIG. 1. The first electrode support layer 11 and/or the second electrode support layer 12 are an elastomer layer which is a dielectric and is made of an elastically deformable elastomer. The adhesion layer 18a is formed by applying, as an adhesive bond, an elastomer in a pre-curing state that is the same material as the elastomer layer and then curing the elastomer.

The first electrode support layer 11, the second electrode support layer 12, and the adhesion layer 18a are a curable elastomer after application. For example, a thermosetting resin or the like can be preferably selected as a material of the first electrode support layer 11, the second electrode support layer 12, and the adhesion layer 18a.

The first electrode support layer 11, the second electrode support layer 12, and the adhesion layer 18a are formed to be elastically deformable by a flexible dielectric made of, for example, a gel of polyvinyl chloride (PVC), polyvinylidene fluoride (PVDF), polydimethylsiloxane (PDMS), a silicon-based resin, a urethane-based resin, an epoxy-based resin, a composite material thereof, or the like. A material that does not have reversibility with respect to a curing process described later can be preferably selected as the elastomer.

Both the first electrode 13 and the second electrode 14 are made of an electric conductor having a stretch property.

The first electrode 13 and the second electrode 14 can be formed of a resin such as a silicon-based resin in which an electric conductor such as carbon, carbon nanofiber, or graphite is incorporated, a resin such as a silicon-based resin containing a metal conductive filler such as silver or copper or the like, a thiophene-based conductive polymer, a conductive resin such as polystyrene sulfonic acid (PSS), or a composite material thereof.

The first electrode 13 is formed in the first electrode support layer 11. The first electrode 13 may be included in a thickness direction of the first electrode support layer 11. The first electrode 13 may be formed to be exposed to any of the surfaces of the first electrode support layer 11. The first electrode 13 may be formed in a predetermined shape when forming the first electrode support layer 11. The first electrode 13 may be formed by incorporating a conductive material such as carbon powder, carbon nanofiber, or metal powder into the same material as the first electrode support layer 11.

In the first electrode 13, the formation shape and the formation position in a thickness direction of the first electrode support layer 11 or in an in-plane direction of the first electrode support layer 11 and the formation number can be set in advance in accordance with the sensor characteristic.

The second electrode 14 may be formed as a predetermined shape when forming the second electrode support layer 12 similarly to the first electrode 13.

The shape or the like of the first electrode support layer 11 and the second electrode support layer 12 is not specifically limited as long as the first electrode support layer 11 and the second electrode support layer 12 are laminated to be capable of being bonded by the adhesion layer 18a. Specifically, other configurations can be employed such as a configuration in which another layer is laminated in the thickness direction between the first electrode support layer 11 and the second electrode support layer 12, a configuration in which another layer is laminated at a position on the opposite side of the second electrode support layer 12 with respect to the first electrode support layer 11 in the thickness direction, or a configuration in which another layer is laminated at a position on the opposite side of the first electrode support layer 11 with respect to the second electrode support layer 12 in the thickness direction.

Next, a capacitance sensor manufacturing method in the present embodiment is described.

FIG. 2 is a flowchart showing a capacitance sensor manufacturing method in the present embodiment. FIG. 3 is a cross-sectional process view showing the capacitance sensor manufacturing method in the present embodiment. FIG. 4 is a cross-sectional process view showing the capacitance sensor manufacturing method in the present embodiment.

The capacitance sensor manufacturing method includes a preparation step S00, an application step S11, and a curing step S12, as shown in FIG. 2. The application step S11 and the curing step S12 constitute a bonding step.

In the preparation step S00, as shown in FIG. 3, the first electrode support layer 11 and the second electrode support layer 12 are prepared. Both the first electrode support layer 11 and the second electrode support layer 12 can be formed in a substantially plate shape. The first electrode support layer 11 and the second electrode support layer 12 can be molded by a predetermined mold or the like. Further, the first electrode support layer 11 and the first electrode 13 can be formed simultaneously at the time of molding. Similarly, the second electrode support layer 12 and the second electrode 14 may be formed simultaneously.

Further, the first electrode support layer 11 and the second electrode support layer 12 can be made of the same material or can be made of a different material.

In the application step S11, as shown in FIG. 4, an adhesive bond 18b is applied to a bonding surface of the first electrode support layer 11 and/or the second electrode support layer 12. At least the surface on which the adhesive bond 18b is applied can be made of an elastomer which is the same as the adhesive bond 18b. The adhesive bond 18b at the time of application is not cured.

In FIG. 4, the adhesive bond 18b is applied to the first electrode support layer 11, but the adhesive bond 18b may be applied to the second electrode support layer 12.

In the curing step S12, the applied adhesive bond 18b is cured by a predetermined process, and thereby, the adhesion layer 18a is formed. A heating process, an ultraviolet irradiation process, or the like can be selected as the curing process in accordance with the material of the elastomer. A process that does not have reversibility with respect to the elastomer, that is, a process to the extent that the first electrode support layer 11 and the second electrode support layer 12 do not exhibit plasticity in the curing process to the adhesive bond 18b, can be preferably selected for the curing process.

By performing the curing process in the curing step S12, it is not necessary for the adhesive bond 18b to bond at a molecular level on the bonding surface with the first electrode support layer 11 and the second electrode support layer 12 made of the elastomer which is the same material, and sufficient bonding and peeling resistance properties can be achieved by a pre-curing adhesive bond 18b entering minute irregularities formed on the bonding surface of the first electrode support layer 11 and the second electrode support layer 12 before bonding and by the adhesive bond 18b being cured in this state to form the adhesion layer 18a.

The capacitance sensor 10 is completed by the first electrode support layer 11 and the second electrode support layer 12 that are bonded by the adhesion layer 18a.

FIG. 5 is a cross-sectional view showing an operation of the capacitance sensor in the present embodiment.

In the capacitance sensor 10 according to the present embodiment, as shown in FIG. 5, in a state where an external load F is not applied, an area in which the first electrode 13 and the second electrode 14 overlap with each other in plan view is S.

On the other hand, when the external load F is applied, an area in which the first electrode 13 located on the right side in FIG. 5 overlaps the second electrode 14 becomes S+ΔS. Thereby, the capacitance formed of the first electrode 13 and the second electrode 14 is changed, and it becomes possible to measure the external load F by detecting this capacitance change.

Similarly, when the external load F is applied, an area in which the first electrode 13 located on the left side in FIG. 5 overlaps the second electrode 14 becomes S−ΔS. In this way, the capacitance formed of the first electrode 13 and the second electrode 14 is changed, and it becomes possible to measure the external load F by detecting this capacitance change.

At this time, the first electrode support layer 11, the second electrode support layer 12, and the adhesion layer 18a are made of an elastomer of the same material. Therefore, the first electrode support layer 11, the second electrode support layer 12, and the adhesion layer 18a have the same stress characteristic. Accordingly, the first electrode support layer 11, the second electrode support layer 12, and the adhesion layer 18a do not have specificity of deformation such as locally different hardness or local softness. The first electrode support layer 11, the second electrode support layer 12, and the adhesion layer 18a have a uniform degree of deformation. That is, the first electrode support layer 11, the second electrode support layer 12, and the adhesion layer 18a are similarly deformed with respect to the applied external load F. Thereby, it becomes possible to accurately detect the change in capacitance between the first electrode 13 and the second electrode 14.

Further, both an interface between the first electrode support layer 11 and the adhesion layer 18a and an interface between the second electrode support layer 12 and the adhesion layer 18a are capable of maintaining a state of having the same stress characteristic. Therefore, the first electrode support layer 11, the second electrode support layer 12, and the adhesion layer 18a are similarly deformed with respect to the applied external load F. Accordingly, discontinuity in the deformation characteristic on the bonding surface does not occur. That is, the first electrode support layer 11, the second electrode support layer 12, and the adhesion layer 18a are similarly deformed regardless of the presence or absence of the bonding surface with respect to the applied external load F. Thereby, it becomes possible to accurately detect the change in capacitance between the first electrode 13 and the second electrode 14.

Further, since the interface between the first electrode support layer 11 and the adhesion layer 18a and the interface between the second electrode support layer 12 and the adhesion layer 18a are formed of the same material and thereby have a uniform characteristic, stress concentration does not occur, and it is possible to enhance the peeling resistance property. Further, at the interface between the first electrode support layer 11 and the adhesion layer 18a, and at the interface between the second electrode support layer 12 and the adhesion layer 18a, since the layers are formed of elastomers having the same molecular structure, the bond is strong, and the layers are not easily peeled from each other.

In FIG. 5, the applied external load F is directed in the rightward-leftward direction in the drawing: however, the external load F can be applied in the thickness direction of the first electrode support layer 11 and the second electrode support layer 12. In this case, the change in capacitance between the first electrode 13 and the second electrode 14 is detected by an interelectrode distance d.

Further, in the present embodiment, at both sides of the adhesion layer 18a, which is a boundary between the first electrode support layer 11 and the second electrode support layer 12 layer corresponding to the first electrode 13 and the second electrode 14, the flexibility is not changed, and it is possible to provide a uniform characteristic. Further, since the molecular structures of the first electrode support layer 11, the second electrode support layer 12, and the adhesion layer 18a are the same, bonding between the layers can be strengthened, and it is possible to provide advantages such as peeling not easily occurring.

Hereinafter, a capacitance sensor and a capacitance sensor manufacturing method according to a second embodiment of the present invention will be described with reference to the drawings.

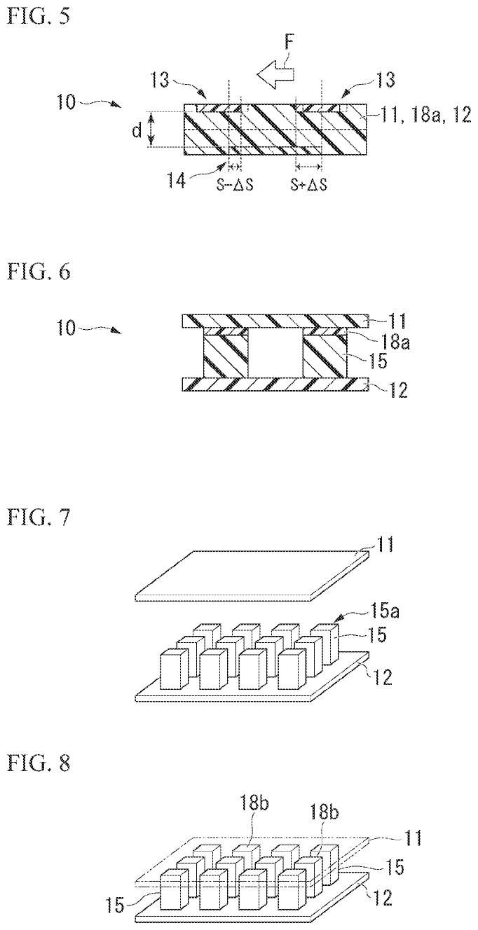

FIG. 6 is a cross-sectional view showing the capacitance sensor in the present embodiment. The present embodiment is different from the first embodiment described above in terms of a pillar. Other configurations corresponding to those of the first embodiment described above are denoted by the same reference numerals, and descriptions thereof are omitted. In FIG. 6, the first electrode 13 and the second electrode 14 are not shown in the drawings.

In a capacitance sensor 10 in the present embodiment, as shown in FIG. 6, a plurality of pillars 15 having a column shape are formed between the first electrode support layer 11 and the second electrode support layer 12.

A plurality of pillars 15 are formed along an in-plane direction of the first electrode support layer 11 and the second electrode support layer 12 and are spaced from each other. The pillars 15 are formed integrally with the second electrode support layer 12. All of the pillars 15 can have the same height. The pillars 15 can have different heights depending on an in-plane position of the first electrode support layer 11 and the second electrode support layer 12. The heights of the pillars 15 can be changed to be inclined in one direction. The heights of the pillars 15 can be set in accordance with the sensor characteristic.

An end portion of each pillar 15 is bonded to the opposing first electrode support layer 11. All of the end portions 15a of the pillars 15 can be bonded to the first electrode support layer 11. Some of the end portions 15a of the pillars 15 may not be bonded to the first electrode support layer 11. An adhesion layer 18a is formed between a bonding section of the end portion 15a of the pillar 15 and the first electrode support layer 11. The adhesion layer 18a can be formed on the bonding section of the pillar 15 in the entire end portion 15a. The adhesion layer 18a can be formed on the bonding section of the pillar 15 in part of the end portion 15a.

The first electrode support layer 11, the second electrode support layer 12, the pillar 15, and the adhesion layer 18a can be made of the same material. The first electrode support layer 11, the second electrode support layer 12, the pillar 15, and the adhesion layer 18a are formed of the same elastomer similarly to the first embodiment.

Next, a capacitance sensor manufacturing method in the present embodiment is described.

FIG. 7 is a perspective view showing a process of the capacitance sensor manufacturing method in the present embodiment. FIG. 8 is a perspective view showing a process of the capacitance sensor manufacturing method in the present embodiment.

The capacitance sensor manufacturing method in the present embodiment includes a preparation step S00, an application step S11, and a curing step S12, similarly to the first embodiment shown in FIG. 2.

In the preparation step S00, as shown in FIG. 7, the first electrode support layer 11 and the second electrode support layer 12 are prepared. The first electrode support layer 11 can be formed in a substantially plate shape. The second electrode support layer 12 can be formed in a substantially plate shape integrally with the pillar 15 in which a plurality of columns are provided to stand. The first electrode support layer 11 and the second electrode support layer 12 can be molded by a predetermined mold or the like. Further, the first electrode support layer 11 and the first electrode 13 can be formed simultaneously at the time of molding. Similarly, the second electrode support layer 12, the second electrode 14, and the pillar 15 may be formed simultaneously.

Further, the first electrode support layer 11, the second electrode support layer 12, and the pillar 15 can be made of the same material or can be made of a different material.

In the application step S11, as shown in FIG. 8, the adhesive bond 18b is applied to a bonding surface of the end portion 15a of the pillar 15. At least the end portion 15a on which the adhesive bond 18b is applied can be made of an elastomer which is the same as the adhesive bond 18b. The adhesive bond 18b at the time of application is not cured. The adhesive bond 18b can be applied to the first electrode support layer 11 which is the bonding location.

In FIG. 8, the adhesive bond 18b is applied to the end portion 15a of the pillar 15, but the adhesive bond 18b may be applied to a front surface of the first electrode support layer 11.

In the curing step S12, the applied adhesive bond 18b is cured by a predetermined process, and thereby, the adhesion layer 18a is formed.

By performing the curing process in the curing step S12, it is not necessary for the adhesive bond 18b to bond at a molecular level on the bonding surface with the first electrode support layer 11 and the end portion 15a of the pillar 15 made of the elastomer which is the same material, and sufficient bonding and peeling resistance properties can be achieved by a pre-curing adhesive bond 18b entering minute irregularities formed on the bonding surface of the first electrode support layer 11 and the end portion 15a of the pillar 15 before bonding and by the adhesive bond 18b being cured in this state to form the adhesion layer 18a.

The capacitance sensor 10 is completed by the first electrode support layer 11 and the second electrode support layer 12 that are bonded by the adhesion layer 18a.

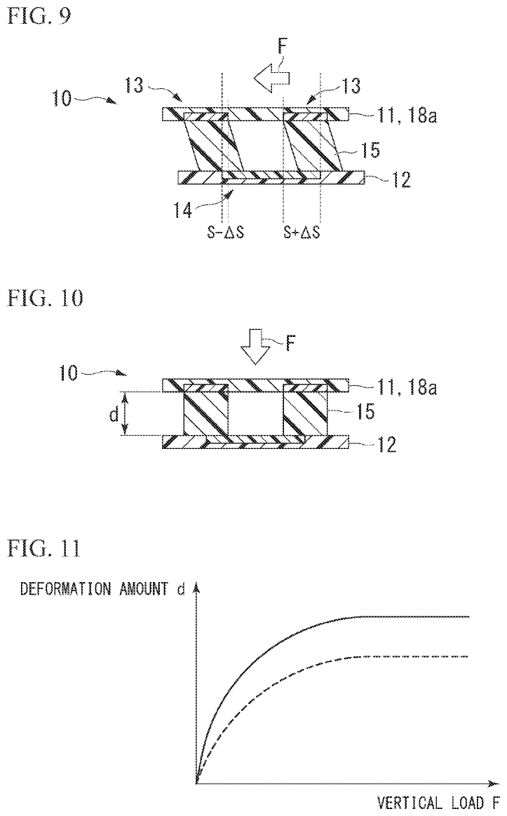

FIG. 9 is a cross-sectional view showing an operation of the capacitance sensor in the present embodiment.

In the capacitance sensor 10 according to the present embodiment, as shown in FIG. 9, in a state where an external load F is not applied, an area in which the first electrode 13 and the second electrode 14 overlap with each other in plan view is S.

On the other hand, when the external load F is applied, an area in which the first electrode 13 located on the right side in FIG. 9 overlaps the second electrode 14 becomes S+ΔS. Similarly, when the external load F is applied, an area in which the first electrode 13 located on the left side in FIG. 9 overlaps the second electrode 14 becomes S−ΔS.

Thereby, the capacitance formed of the first electrode 13 and the second electrode 14 is changed, and it becomes possible to measure the external load F by detecting this capacitance change.

At this time, in the capacitance sensor 10 according to the present embodiment, since bonding is achieved by the adhesion layer 18a located at the end portion 15a of the plurality of pillars 15 spaced from each other in the in-plane direction compared to the first embodiment in which the entire surface of the first electrode support layer 11 and the second electrode support layer 12 is bonded by the adhesion layer 18a, the position change in the in-plane direction between the first electrode support layer 11 and the second electrode support layer 12 more easily occurs. That is, the sensitivity as the sensor characteristic can be improved.

At this time, the first electrode support layer 11, the second electrode support layer 12, the pillar 15, and the adhesion layer 18a are made of an elastomer of the same material. Therefore, the first electrode support layer 11, the second electrode support layer 12, the pillar 15, and the adhesion layer 18a have the same stress characteristic. Accordingly, the first electrode support layer 11, the second electrode support layer 12, the pillar 15, and the adhesion layer 18a do not have specificity of deformation such as locally different hardness or local softness. The first electrode support layer 11, the second electrode support layer 12, the pillar 15, and the adhesion layer 18a have a uniform degree of deformation. That is, the first electrode support layer 11, the second electrode support layer 12, and the adhesion layer 18a are similarly deformed with respect to the applied external load F. Thereby, it becomes possible to accurately detect the change in capacitance between the first electrode 13 and the second electrode 14.

Further both an interface between the first electrode support layer 11 and the adhesion layer 18a and an interface between the end portion 15a of the pillar 15 and the adhesion layer 18a are capable of maintaining a state of having the same stress characteristic. Therefore, the first electrode support layer 11, the second electrode support layer 12, the pillar 15, and the adhesion layer 18a are similarly deformed with respect to the applied external load F. Accordingly, discontinuity in the deformation characteristic on the bonding surface does not occur. That is, the first electrode support layer 11, the second electrode support layer 12, the pillar 15, and the adhesion layer 18a are similarly deformed regardless of the presence or absence of the bonding surface with respect to the applied external load F. Thereby, it becomes possible to accurately detect the change in capacitance between the first electrode 13 and the second electrode 14.

Further, since the interface between the first electrode support layer 11 and the adhesion layer 18a and the interface between the pillar 15 and the adhesion layer 18a are formed of the same material and thereby have a uniform characteristic, stress concentration does not occur, and it is possible to enhance the peeling resistance property. Further, at the interface between the first electrode support layer 11 and the adhesion layer 18a, and at the interface between the pillar 15 and the adhesion layer 18a, since the layers are formed of elastomers having the same molecular structure, the bond is strong, and the layers are not easily peeled from each other.

Specifically, although the end portion 15a of the pillar 15 is a structure at which stress easily concentrates and peeling easily occurs, since the layers made of the same elastomer are bonded to each other, the bond is strong, and the layers are not easily peeled from each other.

FIG. 10 is a cross-sectional view showing an operation of the capacitance sensor in the present embodiment.

As shown in FIG. 10, the external load F can also be applied in a thickness direction of the first electrode support layer 11 and the second electrode support layer 12 so that the applied external load F is directed in an upward-downward direction of the drawing. In this case, the change in capacitance between the first electrode 13 and the second electrode 14 is detected by an interelectrode distance d.

At this time, in the capacitance sensor 10 according to the present embodiment, since bonding is achieved by the adhesion layer 18a located at the end portion 15a of the plurality of pillars 15 spaced from each other in the in-plane direction compared to the first embodiment in which the entire surface of the first electrode support layer 11 and the second electrode support layer 12 is bonded by the adhesion layer 18a, the position change in the thickness direction between the first electrode support layer 11 and the second electrode support layer 12 more easily occurs. That is, the sensitivity as the sensor characteristic can be improved.

FIG. 11 is a view showing a relationship between a vertical load and a deformation amount for describing the operation of the capacitance sensor in the present embodiment.

The first electrode support layer 11, the second electrode support layer 12, the pillar 15, and the adhesion layer 18a are formed of the same elastomer and therefore similarly deform with respect to the external load F which is a compressive force in the thickness direction.

As shown in FIG. 11, when the adhesion layer 18a is made of a material different from the first electrode support layer 11, the second electrode support layer 12, and the pillar 15, in particular, when the adhesion layer 18a is formed of a material that is harder than the first electrode support layer 11, the second electrode support layer 12, and the pillar 15, the deformation amount of the interelectrode distance (interlayer distance) d between the first electrode support layer 11 and the second electrode support layer 12 due to compression is small as indicated by a dashed line. On the other hand, when the first electrode support layer 11, the second electrode support layer 12, the pillar 15, and the adhesion layer 18a are formed of the same elastomer, the deformation amount of the interlayer distance d between the first electrode support layer 11 and the second electrode support layer 12 due to compression is large as indicated by a solid line. That is, the sensitivity as the sensor characteristic can be improved.

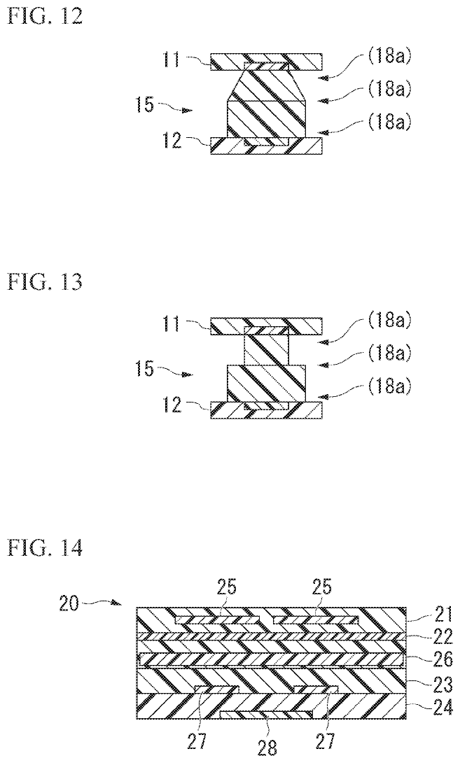

FIG. 12 is a cross-sectional view showing another example of a pillar in the capacitance sensor in the present embodiment. FIG. 13 is a cross-sectional view showing still another example of a pillar in the capacitance sensor in the present embodiment.

The above embodiment is described using an example in which the pillar 15 has the same diameter in the thickness direction of the first electrode support layer 11 and the second electrode support layer 12; however, as shown in FIG. 12 and FIG. 13, a pillar 15 having a different diameter in the height direction can also be used.

For example, as shown in FIG. 12 and FIG. 13, a pillar 15 that becomes thinner toward the first electrode support layer 11 from the second electrode support layer 12 can also be used. Specifically, FIG. 12 shows a pillar 15 including: a portion close to the second electrode support layer 12 having the same width: and a portion that is inclined and becomes thinner toward the first electrode support layer 11 from the vicinity of the middle between the second electrode support layer 12 and the first electrode support layer 11. FIG. 13 shows a pillar 15 including: a portion close to the second electrode support layer 12 having the same width: a step formed in the vicinity of the middle between the second electrode support layer 12 and the first electrode support layer 11: and a portion close to the first electrode support layer 11 that is thin.

Further, in these cases, as shown in FIG. 12 and FIG. 13, the total height of the pillar 15 can be formed integrally with the second electrode support layer 12, and the adhesion layer 18a can be formed at a boundary position with the first electrode support layer 11. Alternatively, the upper half of the pillar 15 can be formed integrally with the first electrode support layer 11, the lower half of the pillar 15 can be formed integrally with the second electrode support layer 12, and the adhesion layer 18a can be formed in the middle of the pillar 15 which is the vicinity of the middle between the second electrode support layer 12 and the first electrode support layer 11. Alternatively, the total height of the pillar 15 can be formed integrally with the first electrode support layer 11, and the adhesion layer 18a can be formed at a boundary position with the second electrode support layer 12.

Hereinafter, a capacitance sensor and a capacitance sensor manufacturing method according to a third embodiment of the present invention will be described with reference to the drawings.

FIG. 14 is a cross-sectional view showing the capacitance sensor in the present embodiment. The present embodiment is different from the first embodiment described above in terms of the lamination of layers made of an elastomer.

A capacitance sensor 20 in the present embodiment has a first electrode support layer 21, a second electrode support layer 22, a third electrode support layer 23, and a fourth electrode support layer 24, as shown in FIG. 14. The first electrode support layer 21 has a first electrode 25. The second electrode support layer 22 has a second electrode 26. The third electrode support layer 23 has a third electrode 27. The fourth electrode support layer 24 has a fourth electrode 28.

The first electrode support layer 21, the second electrode support layer 22, the third electrode support layer 23, and the fourth electrode support layer 24 correspond to the first electrode support layer 11 and the second electrode support layer 12 of the first and second embodiments, are laminated on each other, and are bonded to each other by an adhesion layer. The first electrode support layer 21, the second electrode support layer 22, the third electrode support layer 23, the fourth electrode support layer 24, and each adhesion layer are formed of the same elastomer similarly to the first and second embodiments. Formation of the adhesion layer and bonding of each electrode support layer are similar to those of the first and second embodiments. Each adhesion layer is not shown in the drawing.

The first electrode support layer 21 and the second electrode support layer 22 constitute a proximity sensor. The third electrode support layer 23 and the fourth electrode support layer 24 constitute a proximity sensor. Here, the second electrode 26 constitutes a GND shield layer. The second electrode 26 can be formed on the entire surface of the first electrode support layer 21, the second electrode support layer 22, the third electrode support layer 23, and the fourth electrode support layer 24 so as to electrically shield the first electrode 25, the third electrode 27, and the fourth electrode 28. Thereby, the upper proximity sensor constituted of the first electrode support layer 21 and the second electrode support layer 22 and the lower proximity sensor constituted of the third electrode support layer 23 and the fourth electrode support layer 24 can perform proximity detection on the upper side of the capacitance sensor 20 and proximity detection on the lower side of the capacitance sensor 20, respectively.

In the capacitance sensor 20 in the present embodiment, the electrode support layers corresponding to the electrodes can be formed separately, and each layer can be bonded by the adhesion layer constituted of an elastomer made of the same material. Here, each electrode support layer can be formed as a configuration divided in the thickness direction for each electrode formed at a different position in the thickness direction of the capacitance sensor 20. That is, depending on the electrode position arranged according to the desired sensor characteristic needs, the layers can be separated into multiple stages and bonded. Thereby, it is possible to facilitate manufacturing of the capacitance sensor 20, improve sensor sensitivity, and improve peeling resistance.

In this case, electrodes having a different position in the thickness direction can be arranged in the same electrode support layer so as not to overlap each other in plan view.

At the same time, since it becomes easy to manufacture the capacitance sensor 20 having a complex multilayer structure, it becomes possible to provide a configuration in which a sensor having a different characteristic is further added.

Here, it becomes easy to form a pillar between the electrode support layers as in the second embodiment as needed and improve the sensor characteristic.

In the capacitance sensor 20 in the present embodiment, since the layers and the adhesion layer between the layers are formed of the same elastomer, it is possible to provide advantages similar to those of the embodiments described above. Further, the first electrode 25 can measure proximity data with the outside of the sensor, and the third electrode 27 and the fourth electrode 28 can measure a three-axis force of an applied load.

In this case, the second electrode 26 is a ground electrode for separating the proximity sensor and the three-axis force sensor described above and can provide a GND shield effect.

Here, in a sensor that acquires the proximity by way of a change in a capacitance value and acquires the pressure by way of a resistance value, a data acquisition circuit is required for each acquisition. On the other hand, in the present embodiment, both the proximity and the three-axis force can be acquired by the capacitance sensor 20 which is one capacitance-type sensor. Accordingly, the capacitance sensor 20 in the present embodiment can provide advantages such as decreasing the size of a measurement circuit and downsizing the system.

As another form, the first electrode 25 can be eliminated, and the second electrode 26 can be used as a self-capacity proximity sensor. In this case, the timing of acquiring the pressure by the third electrode 27 and the fourth electrode 28 and the timing of acquiring the proximity data by the second electrode 26 can be switched in a time division manner.

Further, in the embodiments described above, the electrode support layers are constituted of the same material; however, for example, in the first embodiment, the first electrode support layer 11 can be made of an elastomer layer, and the second electrode support layer 12 can be made of a rigid substrate. Even in this case, it is possible to improve a bonding state between the first electrode support layer 11 and the adhesion layer 18a.

Further, in the second embodiment, the second electrode support layer 12 and the pillar 15 can be formed of an elastomer, and the first electrode support layer 11 can be made of a flexible substrate. Even in this case, it is possible to improve a bonding state between the second electrode support layer 12 and the adhesion layer 18a.

Further, in the present invention, individual configurations in the embodiments described above can be individually selected and combined.

What is claimed is:

1. A capacitance sensor made of a plurality of layers, the capacitance sensor comprising:
a first layer including a first electrode; and
a second layer including a second electrode and arranged to face the first layer,
wherein at least one of the first layer and the second layer is an elastomer layer which is a dielectric and is made of an elastically deformable elastomer, and
the elastomer layer is bonded by an adhesion layer formed by applying an elastomer in a pre-curing state that is a material identical to the first layer or the second layer and curing the elastomer.

2. The capacitance sensor according to claim 1, including
between the first layer and the second layer, a plurality of pillars extending in a lamination direction, in which the first layer and the second layer face each other, and arranged to be spaced from each other in a direction intersecting the lamination direction,
wherein the pillars are bonded by the adhesion layer, which is a material made of an elastomer identical to the first layer or the second layer.

3. The capacitance sensor according to claim 2,
wherein the pillar is integrally formed with at least one of the first layer and the second layer.

4. A capacitance sensor manufacturing method of a capacitance sensor made of a plurality of layers and comprising: a first layer including a first electrode; and a second layer including a second electrode arranged to face the first layer, the capacitance sensor manufacturing method including:
a preparation step in which an elastomer layer that is a dielectric and is made of an elastically deformable elastomer is formed as at least one of the first layer and the second layer; and
a bonding step in which an elastomer in a pre-curing state that is a material identical to the first layer or the second layer is applied and then cured, and an adhesion layer that bonds the elastomer layer is formed.

5. The capacitance sensor manufacturing method according to claim 4,
wherein a plurality of pillars that extend in a lamination direction in which the first layer and the second layer face each other, are arranged to be spaced from each other in a direction intersecting the lamination direction, and are a material identical to the first layer or the second layer are provided between the first layer and the second layer, and
in the bonding step, the pillars are bonded by the adhesion layer.
